(19) United States
(12) Patent Application Publication
(10) Pub. No.: US 2018/0347243 A1
(43) Pub. Date: Dec. 6, 2018

(54) DOUBLE DOOR LATCH AND LOCK ASSEMBLY

(71) Applicant: SafeCorp Financial Services Pty Ltd, Braeside Vic (AU)

(72) Inventor: Andrew Ryan, Victoria (AU)

(21) Appl. No.: 15/610,282

(22) Filed: May 31, 2017

(51) Int. Cl. E05C 7/02; E05C 3/00; E05C 3/08; E05C 3/10; E05C 21/00; E05B 47/00; E05C 9/00

(52) U.S. Cl. CPC E05C 7/02; E05C 3/004; E05C 3/08; E05B 13/002; E05C 21/00; E05B 47/0012; E05C 9/00; E05C 3/10

(57) ABSTRACT

A latch and lock assembly for a double door arrangement having a first door and a second door, in use, being pivotally mounted for movement about either a common pivot axis or closely adjacent parallel pivot axis to a door frame. The latch and lock assembly include: a releasably latching mechanism operatively adapted to releasably latch at least one of the first and second doors to the door frame; a releasable connection mechanism operatively adapted to releasably connect the first door to the second door; and an operating system operatively adapted to control both the latching mechanism and the connection mechanism. The operating system includes an electrical drive operable by an electric power source to drive an actuator that operates the releasable latching mechanism, the releasable connection mechanism, or both.

### CROSS-REFERENCE TO RELATED APPLICATIONS

This application is related to Australian Application Nos. 2016219722, filed 26 Aug. 2016 and 2015903493, filed 28 Aug. 2015 and Australian Patent No. 771114, the disclosures of which are hereby incorporated by reference.

### FIELD OF THE INVENTION

This invention relates to a latch and lock assembly particularly adapted to latch and lock a double door arrangement such as, for example, a double door arrangement with an inner door and an outer door, both being hinged on the same hinge axis or on two closely adjacent hinge axes. The inner door may be a relatively solid or secure door and the outer door might be a screen door. Such double door assemblies are commonly used in transportable homes or caravans but the current invention, while usable in such applications, is not limited thereto.

### BACKGROUND

Australian Patent No. 771114 discloses a latch and lock assembly for a double door arrangement typically for use in caravans. In this disclosure, the latch and lock assembly is mechanically configured and operated primarily by rotation of a conventional key in a key barrel. The latch and lock assembly of Australian Patent No. 771114 can either hold the inner and outer doors connected together so that the two doors are able to swing in connected movement, or the latch and lock assembly can selectively release the two doors so that each door can be moved from a closed to an open position independently of the other. The latch and lock assembly of Australian Patent No. 771114 includes a releasable locking mechanism that is adapted to latch at least one of the two doors to a surrounding door frame, and also includes as releasable connection mechanism that is adapted to releasably connect the two doors. A mechanical operating mechanism including a handle, allows a user to control both the latching of the door to the surround frame and the connection or separation of the doors to or from one another. Actuation of the handle of the operating mechanism by a first predetermined movement releases the latching of the door or doors from the surround frame and by a second predetermined movement releases the door connection mechanism to allow the doors to be separated. The arrangement disclosed in Australian Patent No. 771114 has been successfully used for a number of years.

By this reference to the specification of Australian Patent No. 771114, we incorporate herein so much of its disclosure as is necessary for a proper understanding of the present invention as described hereafter.

### SUMMARY

An object of the present invention is to provide a latch and lock assembly of the aforementioned kind that provides greater security and simplicity of use by including in such a latch and lock design actuation by electrical drive means in association with an electrical based actuator, in addition to the existing mechanical system whereby the electrical actuation and the mechanical actuation systems can work independently of each other.

Accordingly, in a first aspect, the present invention provides a latch and lock assembly for a double door arrangement having a first door and a second door, in use, being pivotally mounted for movement about either a common pivot axis or closely adjacent parallel pivot axis to a door frame, the latch and lock assembly being selectively operable to hold the first door to the second door in a connected mode for connected pivotal movement or to release said first and said second doors from said connected mode whereby said first and said second doors are capable of independent pivotal movement, said latch and lock assembly further enabling at least one of said first or said second doors to be releasably latched to or latched and locked to said door frame, the latch and lock assembly including: a releasably latching mechanism operatively adapted to releasably latch at least one of said first and said second doors to the door frame; a releasable connection mechanism operatively adapted to releasably connect the first door to the second door; and an operating system operatively adapted to control both the latching mechanism and the connection mechanism, said operating system including an electrical drive means operable by an electric power source to drive actuating means operating at least one of said releasable latching mechanism or said releasable connection means.

The drive actuating means driven by the electrical drive means may drive only one of the releasable latching mechanism or the releasable connection mechanism, the other of said releasable latching mechanism or said releasable connection mechanism being operated by external mechanical manipulation. Alternatively, the drive actuating means driven by the electrical drive means may drive both the releasable latching mechanism and the releasable connection mechanism.

The operating system may include a mechanical actuation member operable from an inner side of the double door arrangement, the mechanical actuation member being movable by a first predetermined movement to actuate the latching mechanism and by a second predetermined movement to actuate the connection mechanism. The mechanical actuation member may be a rotatable handle, the first predetermined movement and the second predetermined movement being in opposite rotational direction of said rotatable handle.

Alternatively, the operation system may include first and second mechanical actuation members, operable from an inner side of the double door arrangement, the first mechanical actuation member being moveable to actuate said connection mechanism, and said second mechanical actuation member being movable to actuate said latching mechanism. At least one of said first and said second mechanical actuation members may be a rotatable handle.

A first latch member may be provided, the latch member being mounted rotatably to interact with a latch strike plate fixed to or on said door frame to hold at least one of said first or said second doors in fixed relation to the door frame or to release one or both said first and said second doors from said door frame, said first latch member forming part of said latching mechanism, and rotation of said first latch member causing vertical movement of a driver mechanism which activates at least one additional latch member spaced from said first latch member to provide multiple latching points for the double door arrangement to said door frame. The driver mechanism may include an elongated strip member with gear teeth set at appropriate locations along the elongated strip member to interact with corresponding gear teeth associated with the first latch member and each said additional latch member.

Alternatively or additionally, a first latch member may be provided, the latch member being mounted rotatably to interact with a latch strike plate fixed to or on said door frame to hold at least one of said first or said second doors in fixed relation to the door frame or to release one or both said first and said second doors from the door frame, the first latch member including first drive means engageable with second drive means on an elongated strip member to move said strip member in a longitudinal direction upon rotation of said first latch member towards a release position from said latch strike plate. A rotatable locking member may be co-operable with said elongated strip member whereby in a first rotational position of said rotatable locking member said elongated strip member is prevented from movement in the longitudinal direction, and in a second rotational position of said rotatable locking member, said elongated strip member is capable of movement in said longitudinal direction. The electrical drive means drives a first gear member co-operable with gear formations on said rotatable locking member to selectably rotate said rotatable locking member. A lost motion mechanism may be provided between said first gear member and said electrical drive means. The electric power source may include battery means carried in a housing compartment of the latch and lock assembly located on an inner side of said double door arrangement. The electrical drive means may include a controller arranged to place the electrical drive means in a standby configuration, said controller being activated by activation means located on an external side of the double door arrangement. The controller may be located mounted in or to an external operative lever handle.

### BRIEF DESCRIPTION OF THE DRAWINGS

It will be convenient to further describe the invention with respect to the accompanying drawings which illustrate a preferred embodiment of the lock and latch assembly according to the present invention. Other embodiments of the invention are possible, and consequently, the particularity of the accompanying drawings is not to be understood as superseding the generality of the preceding description of the invention.

In the drawings:

FIG. l is a perspective view of the latch and lock assembly from the outside showing both inner and outer parts with some parts omitted;

FIG. 2 is a perspective view similar to FIG. 1 but from the inside of the latch and lock assembly;

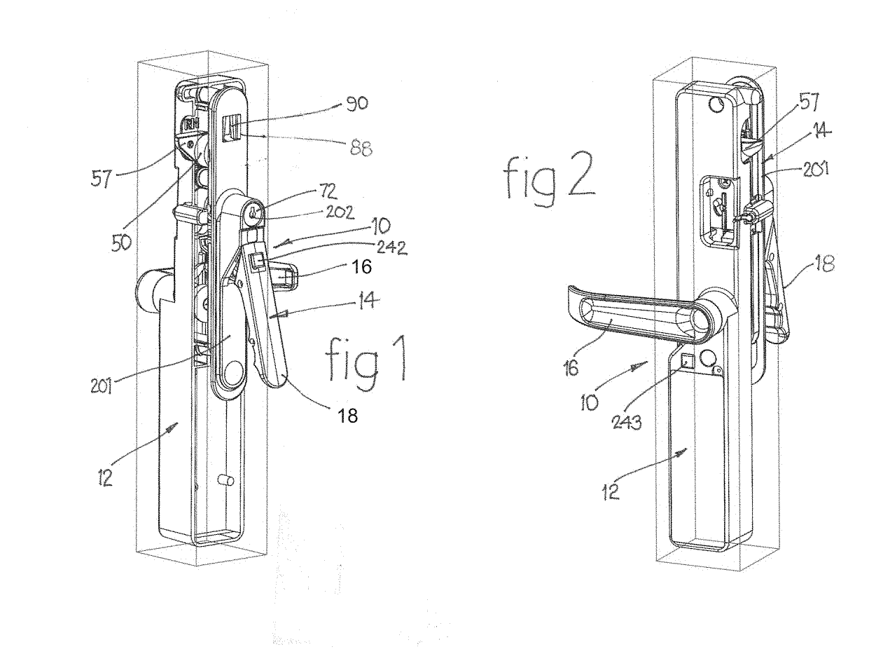

FIG. 3 is a partial detailed perspective view of a section of the latch and lock assembly with parts omitted looking from the inside;

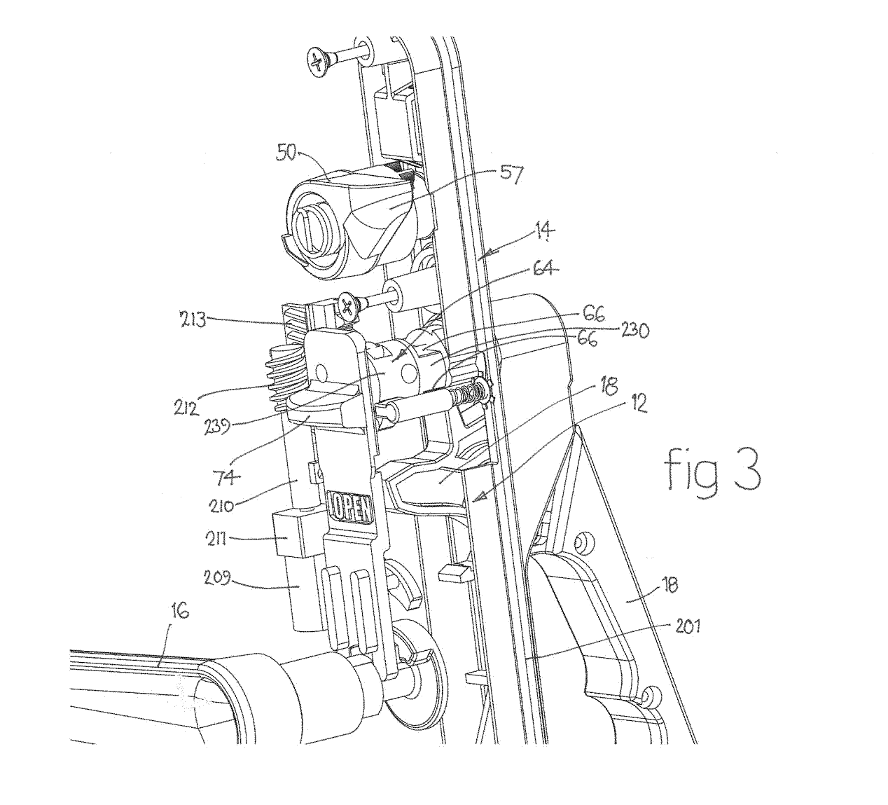

FIG. 4 is a partial detailed perspective view similar to FIG. 3 but with a further part omitted, looking from the outside;

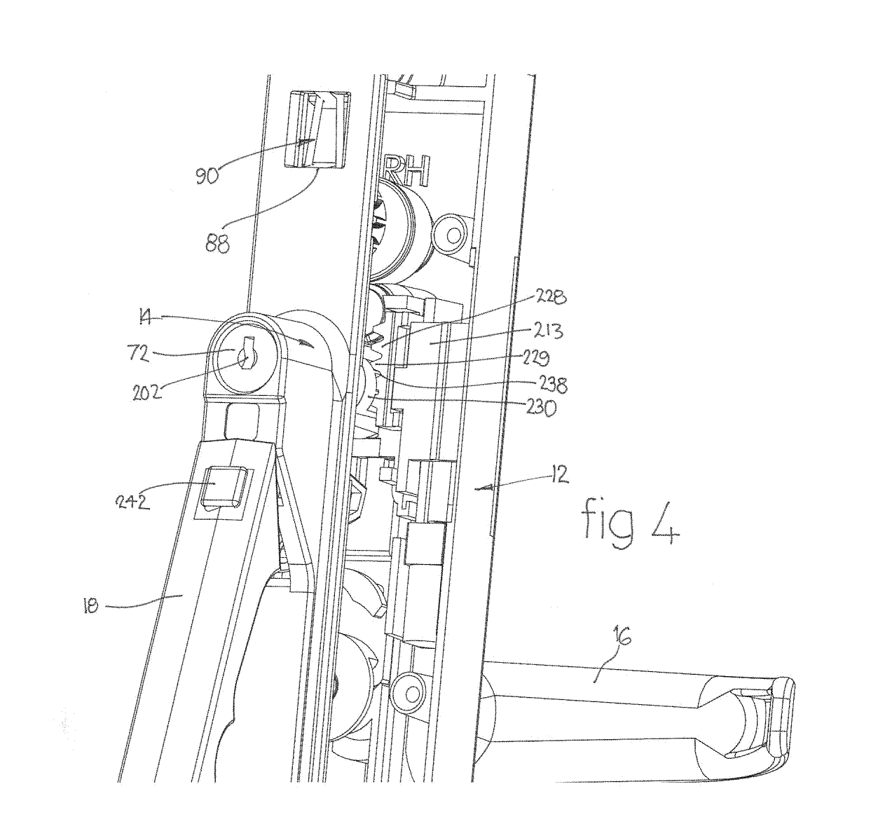

FIG. 5 is a partial detailed perspective view similar to FIG. 4 but with a further part omitted;

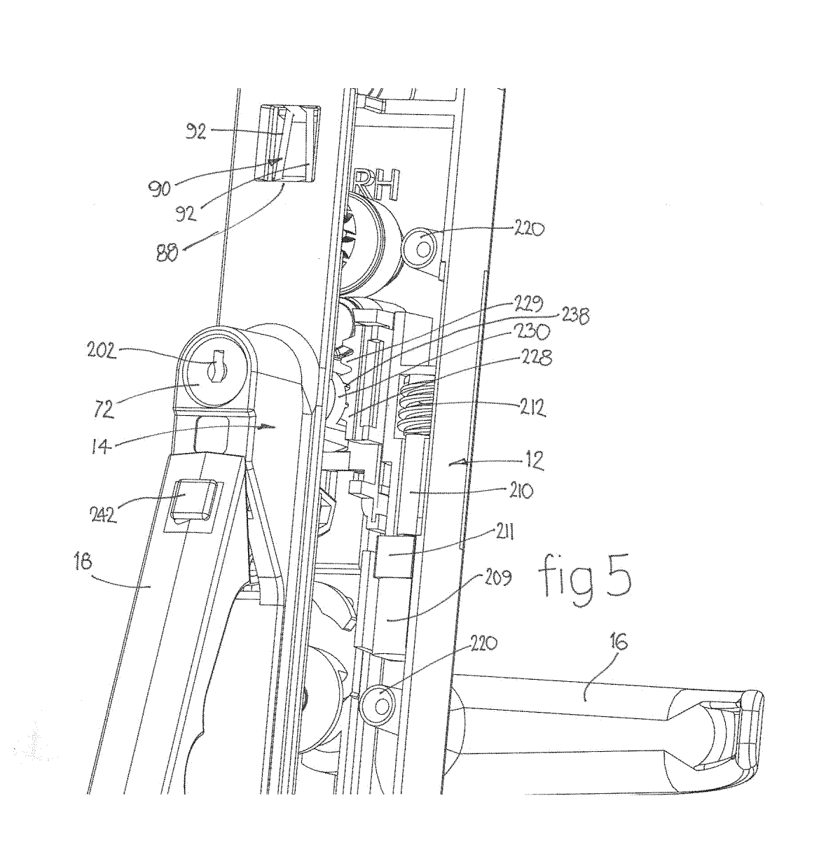

FIG. 6 is a partial underneath perspective view of the inner part of the latch and lock assembly;

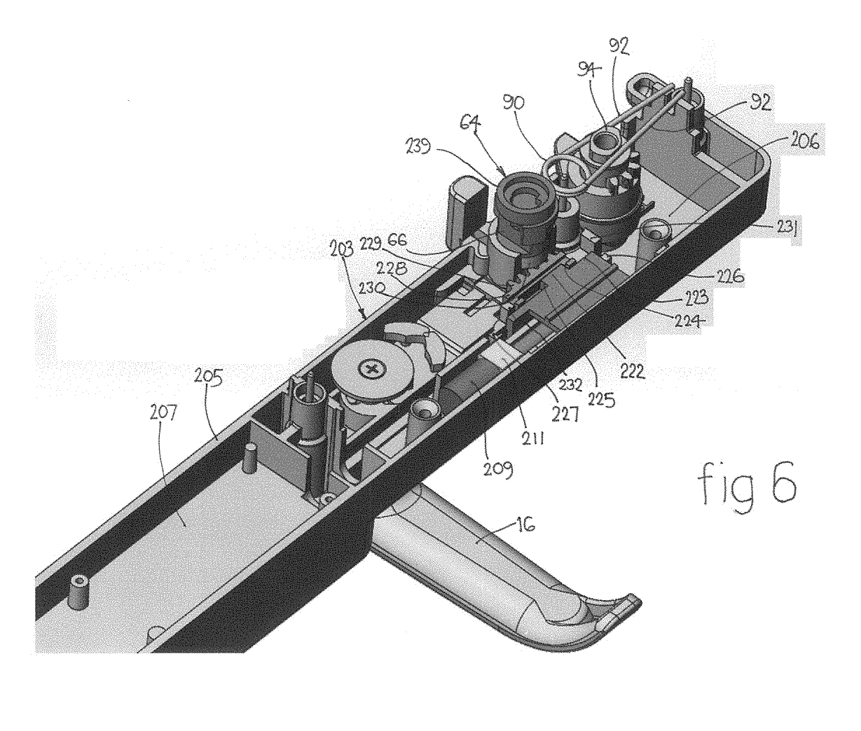

FIG. 7 is a view similar to FIG. 6 but showing additional detail;

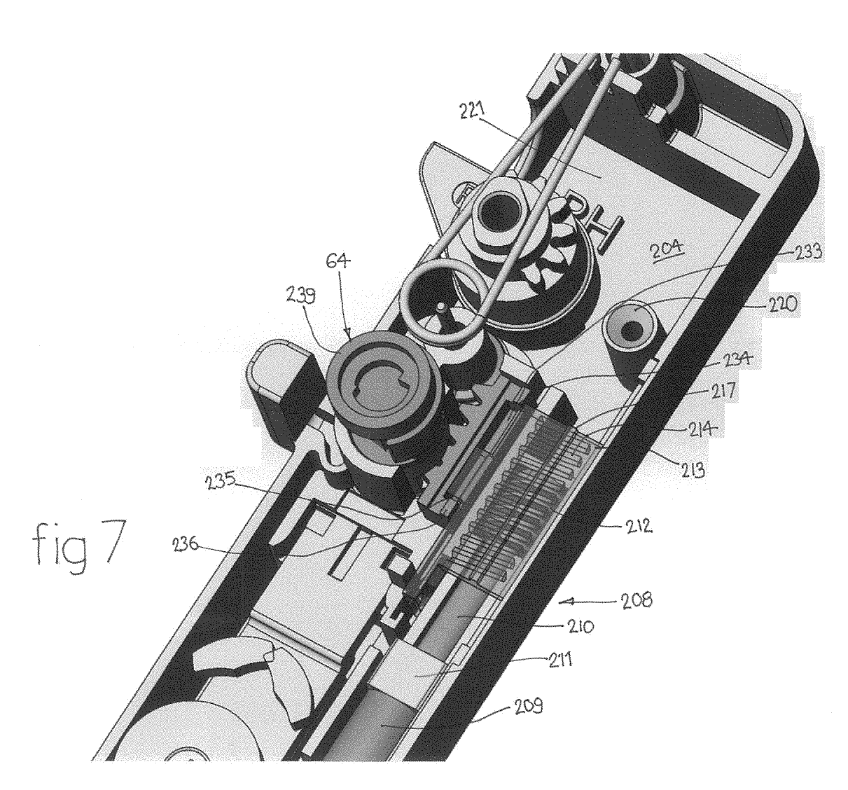

FIG. 8 is a detailed side perspective view illustrating the outer operating handle;

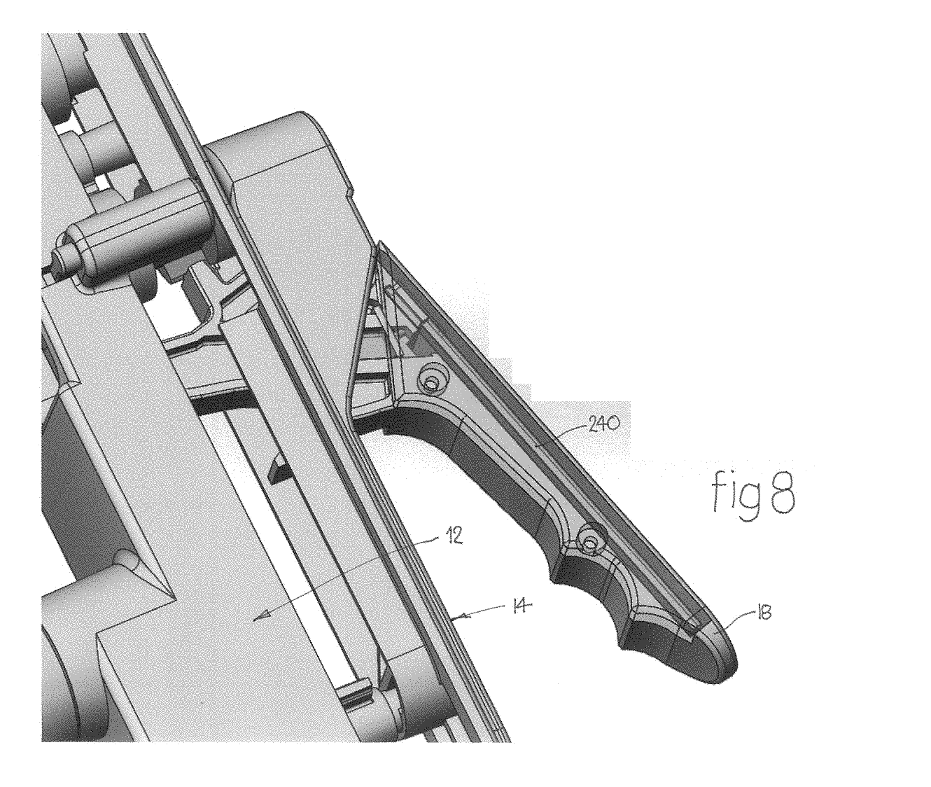

FIG. 9 is a view similar to FIG. 6 including a further part of the sub assembly;

FIG. 10 is a view similar to FIG. 7; and

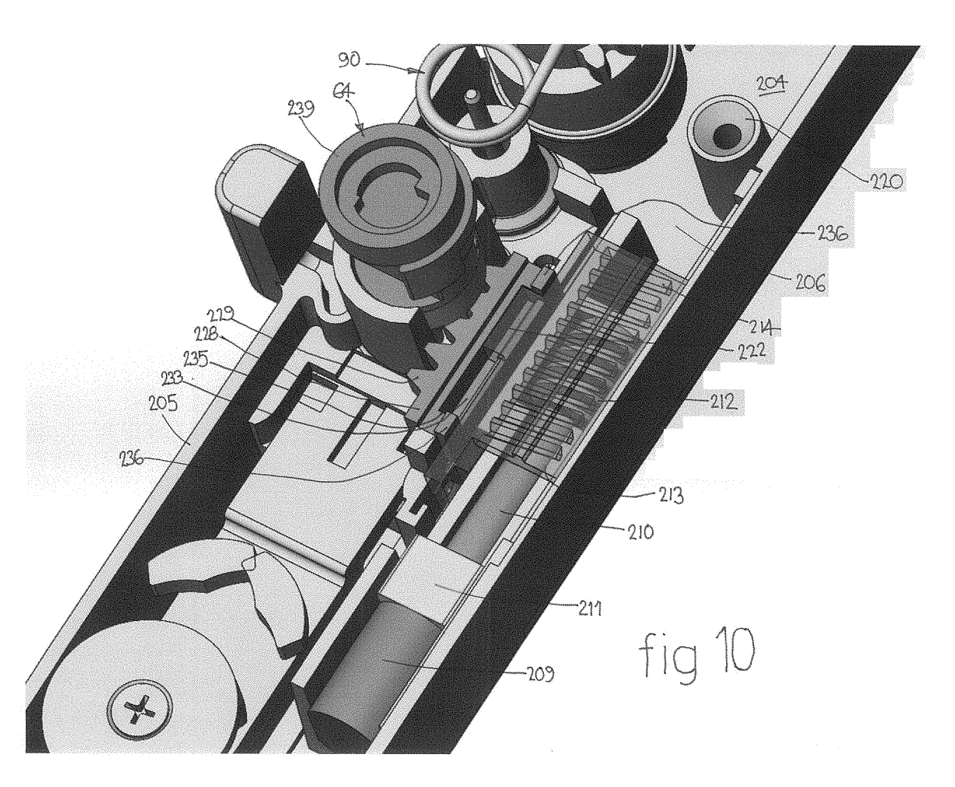

FIG. 11 is a further view of the region shown in FIG. 10 from a different angle.

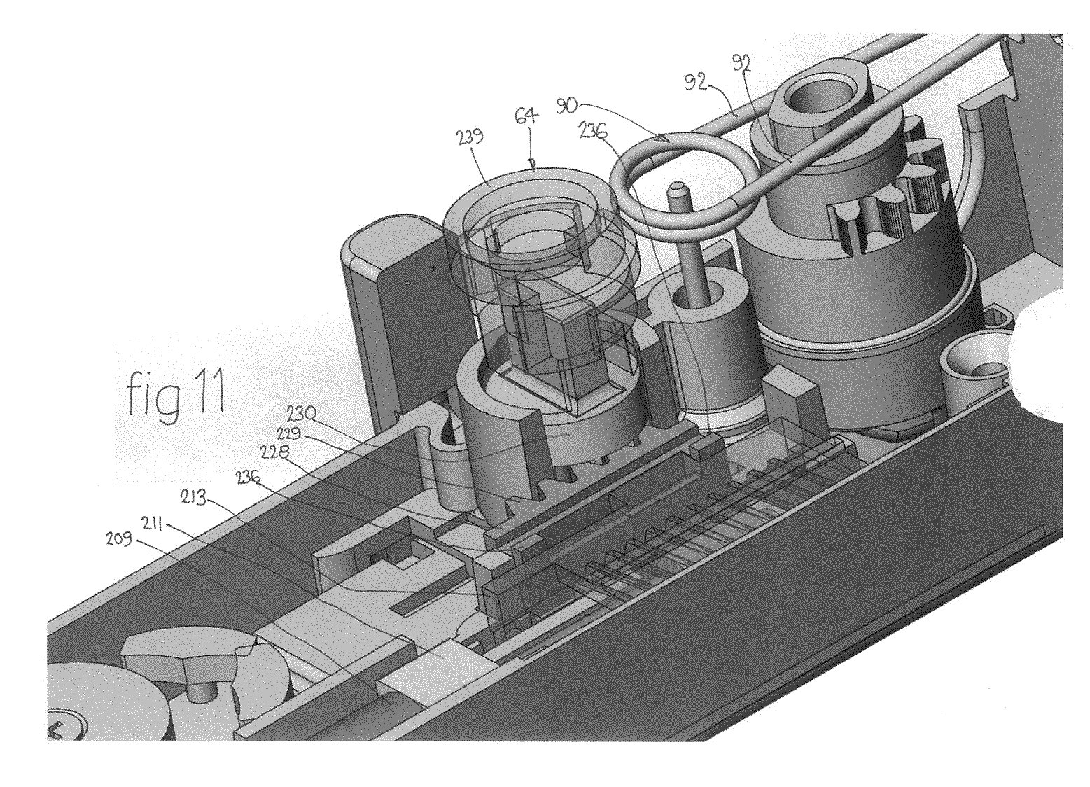

### DETAILED DESCRIPTION OF ILLUSTRATED EMBODIMENT

The latch and lock assembly 10 illustrated in the drawings is adapted for installation on a double door arrangement (not illustrated) having an inner door and an outer door hinged on a common hinge axis or on closely adjacent parallel hinge axis within a common door frame. The latch and lock assembly 10 has an inner part 12 adapted to be mounted on an inwardly facing surface of the inner door and an outer part 14 adapted to be mounted to an outwardly facing surface of the inner door with regions of the outer part extending through an opening in the outer door and in an outer fascia plate (not shown) mounted to the outwardly facing surface of the outer door as is shown in Australian Patent No. 771114, when the inner and outer doors are in a closed latched position. The inner part 12 has a graspable inner handle 16 adapted to be partially rotated to effect selectively either rotation of a latch tongue 57 to disengage same from a latch strike plate (not illustrated) to allow the inner and outer doors to be swung, in connected configuration, to an open position, or to effect separation of the inner door from the outer door. Conveniently, the inner handle 16 might be rotated downwardly to effect disengagement of the latch tongue 57 from the latch strike plate and in an upward direction to effect separation of the inner and outer doors. The mechanisms to achieve such performance are disclosed in Australian Patent No. 771114. In an alternative possible arrangement, the disengagement of the latch tongue 57 from the latch strike pate may be achieved by rotation of the inner handle 16 and a separate actuator operable from the inner side of the double door arrangement might be provided to effect separation of the inner and outer doors when desired.

The inner part 12 further includes a slidable snib component 74 operable by a person standing inside of the double door arrangement, and when the door arrangement is closed, lock the latch and lock assembly without using a key.

On the external side of the inner door, an external lever 18, is pivotally mounted to rotate about a horizontal axis generally parallel to the plate 201 of the outer part 14 from a position generally parallel to the plate 201 to an extended position (FIG. 1) where the lever can be gripped to enable the door to be opened. In moving to the extended position (FIG. 1), the latch tongue 57 is moved to disengage from the latch strike plate (not shown) as is generally described in Australian Patent No. 771114.

The latch tongue 57 is rotatably mounted on a latch member 50. While the illustrated embodiment shows a single latch member 50, it is also envisaged that one or more members having latch tongues be provided to provide multiple latching points for the double door arrangement to the door frame. To this end, a driver mechanism may be provided to activate the additional latch tongues when the latch member 50 is rotated, thereby resulting in vertical movement of the driver mechanism. The driver mechanism includes an elongated strip member having gear teeth set at appropriate locations along the strip member, each set of gear teeth interacting with corresponding gear teeth associated with each latch member.

A resilient biasing means in the form of a spring 90 is mounted to the rear of the plate 201 with the legs 92 of the spring 90 being urged towards one another. A male protruding member is provided on a connector plate located inwardly of the rear face outer fascia plate mounted to an outer surface of the outer door such that when the inner and outer doors are positioned adjacent one another, the male protruding member passes through the aperture 88 in the plate 201 and is held between the legs 92 of the spring 90. In this orientation, the inner and outer doors are held connected together. Actuation of the handle 16 causes the latch member 50 carrying the latch tongue 57 to rotate. The latch member 50 also carries a cam member 94 that, in use is also received between the legs 92 of the spring 90. Thus rotation of handle 16 in a predetermined direction and distance will cause the cam member 94 to spread the legs 92 sufficiently to allow the male protruding member to be disengaged therefrom and allow the inner and outer doors to be separated.

As is described and illustrated in greater detail in Australian Patent No. 771114, the internal handle 16 and the external lever 18 are operable to allow opening of the inner door from the door frame (not shown), with each acting on a metal control strip with formations as shown in Australian Patent No. 771114, with the metal control strip being capable of moving in an up and down direction. A cylinder 64 is rotatably mounted and co-operable with the formations in the metal control strip. The cylinder 64 has opposed cut outs 66 presenting, in one orientation, a guide way to allow the metal strip to move vertically, and in a second orientation, to prevent such vertical movement, of the metal strip. The latch and lock assembly 10 is in an unlocked state when the cut outs 66 are so oriented to allow vertical movement of the metal control strip. When the latch and lock assembly is in a locked state, the cylinder 64 is oriented such that the cut outs are located whereby vertical movement of the metal control strip is prevented.

In one mode of operation, a person standing outside the double door arrangement, can lock the door arrangement with the use of a key in a key barrel 72, the key barrel 72 being rotated following insertion of a key into its key slot 202, enabling rotation of the cylinder 64 to a position blocking vertical movement of the metal control strip. With the metal control strip locked in a vertically fixed position, the latch member 50 and latch tongue 57 is also prevented from movement thus causing locking of the inner door. A person standing inside the double door arrangement can lock the door arrangement when it is in a closed position in the surrounding door frame, by actuating the snib component 74. Moving the same component 74 downwardly serves to rotate the cylinder 64 to its blocking position, thereby blocking movement of the metal control strip and thereby also blocking movement of the latch tongue 57. Further, sliding the snib component downwardly to the locked position, also serves to engage the handle 16 to prevent the handle 16 being rotated to open the latch tongue 57.

The drawings annexed hereto illustrate a further mode of operation in accordance with an embodiment of the present invention. In this further mode, the latch and lock controlling rotatable cylinder 64 is driven by electrical drive means 208 actuated from either inside or outside of the double door arrangement. The inner part 12 of the latch and lock assembly 10 has a fascia housing member 203 having an inwardly facing wall 204 and a peripheral edge wall 205 defining an upper compartment region 206 in which at least part of the operating mechanism is mounted including the controlling rotatable cylinder 64, and a lower compartment region 207 adapted, in use, to house one or more batteries to operate the electrical drive means 208 as described hereafter.

The electrical drive means 208 includes a small electric drive motor 209 positioned, when activated to drive a drive shaft 210 through a gear transmission 211. The drive shaft 210 carries a worm gear 212 at its free end which is positioned to engage with cooperating worm gear formations 214 on a slidably mounted slide plate 213. The slide plate 213 is mounted so as to slide in an up and down direction relative to the housing member 203 when installed in a use position. The slide plate 213 has a face 216 facing, in use, towards an upwardly facing surface of the inner door with a longitudinally extending rib 217 projecting therefrom. The rib 217 is received within a slot 218 in a guide and retention plate 219. The guide and retention plate 219 is secured by fasteners to the screw threaded bores in each boss 220 extending from an inner surface 221 of the wall 204. The slide plate 213 further has an engagement member 222 projecting from an inner edge 223 of the slide plate 213, the engagement member 222 having opposed upper and lower ends 224, 225. The slide plate 213 is arranged to slidably move between upper and lower stop formations 226, 227 integrally formed with the fascia housing member 203.

The electrical drive means 208 further includes a gear plate 228 with a linear gear teeth 229 arranged along an inwardly facing edge positioned, in use adjacent a section 230 of the controlling rotatable cylinder 64. The gear plate 228 is also slidably mounted in the upper compartment region 206 of the fascia housing member 203 between stop formations 231, 232 limiting its movement in an up and down direction. The gear plate 228 includes a recessed section 233 along its edge adjacent the slide plate 213 having defined ends 234, 235. The recessed section 233 receives the engagement member 222 of the slide plate 213 with the distance between the ends 234, 235 of the recessed section 233 being greater than the distance between the ends 224, 225 of the engagement member 222 whereby a degree of lost motion exists between movement of the slide plate 213 and the gear plate 228. However, engagement of the end 225 of the engagement member 222 with the end 235 of the recessed section 233 will enable the gear plate 228 to be driven in a downwards direction. Conversely, engagement of the end 224 of the engagement member 222 with the end 234 of the recessed section 233 will enable the gear plate 228 to be driven in an upwards direction. The gear plate 228 further includes upwardly extending tabs 236 received in a second slot 237 formed in the plate 218 parallel to the slot 218. The tabs 236 sliding in the slot 237 serve to guide up and down movement of the gear plate 228. The gear teeth 229 on the gear plate 228 operably engage with gear teeth formations 238 on the section 230 of the controlling rotatable cylinder 64 whereby linear motion of the gear plate 228 is translated to rotational movement of the section 230 and thereby the controlling rotatable cylinder 64.

Rotation of the rotatable cylinder 64 in a predefined movement direction causes a cam surface on the cylinder 64 to cooperate with a follower part on the external lever 18, to pivot the lever 18 outwardly as shown in FIG. 1. These features are described in greater detail in Australian Patent No. 771114.

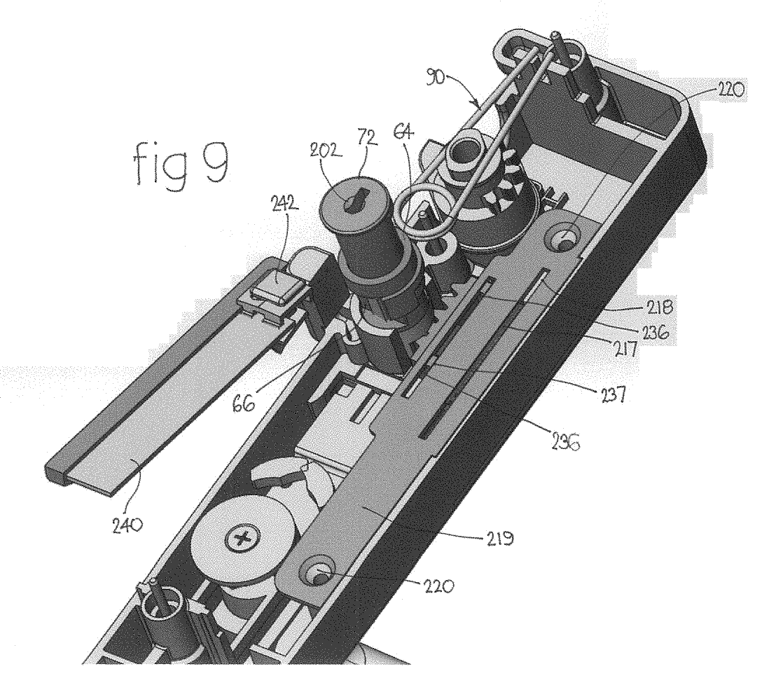

Conveniently, the controlling rotatable cylinder 64 is manufactured in two parts, the outer section 230 and an inner section 239. Conveniently, the inner section 239 cooperates with the key operated key barrel 72 (FIG. 9). The degree of lost motion between the slide member 213 and the gear plate 228 enables the latch and lock assembly 10 to be mechanically operated including use of the key operated key barrel 72 and the internal snib component 74 as well as by the electrical drive means 208.

The electrical drive means 208 may conveniently be controlled via a control system 240 mounted in a recessed zone 241 of the lever handle 18. The control system 208 might be activated by a key tag or similar (not shown). Conveniently to extend battery life, the control system 240 may include a sleep mode including an engagement button 242 to wake up the system whereby the key tag or similar activation device will operate the system. Typically, from the external side with the door arrangement latched and locked, a user will push on or touch the activation button 242 to initially wake up the system and then place the key tag or similar device near the control system 240 mounted in the lever handle 18. This will allow the drive motor 209 to operate to move the slide plate 213 and in response, the gear plate 228 to rotate the cylinder 64. In response, the lever 18 is pivoted to its extended position with the latch tongue 57 being delatched and the door arrangement can be opened by the user gripping the lever 18. Using the electrical drive means mode of operation, latching and locking the door arrangement is achieved by reversing the process. From the inside, a second touch or push button 243 is provided, the operation of which simply locks the latch and lock assembly 10.

1. A latch and lock assembly for a double door arrangement having a first door and a second door, in use, being pivotally mounted for movement about either a common pivot axis or closely adjacent parallel pivot axis to a door frame, the latch and lock assembly being selectively operable to hold the first door to the second door in a connected mode for connected pivotal movement or to release said first and said second doors from said connected mode whereby said first and second doors are capable of independent pivotal movement, said latch and lock assembly further enabling at least one of said first or second doors to be releasably latched to or latched and locked to said door frame, the latch and lock assembly including:
a releasably latching mechanism operatively adapted to releasably latch at least one of said first and said second doors to the door frame;
a releasable connection mechanism operatively adapted to releasably connect the first door to the second door; and
an operating system operatively adapted to control both the latching mechanism and the connection mechanism, said operating system including an electrical drive means operable by an electric power source to drive actuating means operating at least one of said releasable latching mechanism or said releasable connection mechanism.

2. A latch and lock assembly according to claim 1, wherein the drive actuating means driven by the electrical drive means drives only one of the releasable latching mechanism or the releasable connection mechanism, the other of said releasable latching mechanism or said releasable connection mechanism being operated by external mechanical manipulation.

3. A latch and lock assembly according to claim 1, wherein the drive actuating means driven by the electrical drive means drives both the releasable latching mechanism and the releasable connection mechanism.

4. A latch and lock assembly according to claim 1, wherein the operating system includes a mechanical actuation member operable from an inner side of the double door arrangement, the mechanical actuation member being movable by a first predetermined movement to actuate the latching mechanism and by a second predetermined movement to actuate the connection mechanism.

5. A latch and lock assembly according to claim 4, wherein the mechanical actuation member is a rotatable handle, the first predetermined movement and the second predetermined movement being in opposite rotational direction of said rotatable handle.

6. A latch and lock assembly according to claim 1, wherein the operation system includes first and second mechanical actuation members, operable from an inner side of the double door arrangement, the first mechanical actuation member being moveable to actuate said connection mechanism, and said second mechanical actuation member being movable to actuate said latching mechanism.

7. A latch and lock assembly according to claim 6, wherein at least one of said first and said second mechanical actuation members is a rotatable handle.

8. A latch and lock assembly according to claim 4, further comprising a first latch member, the latch member being mounted rotatably to interact with a latch strike plate fixed to or on said door frame to hold at least one of said first or said second doors in fixed relation to the door frame or to release one or both said first and said second doors from said door frame, said first latch member forming part of said latching mechanism, and rotation of said first latch member causing vertical movement of a driver mechanism which activates at least one additional latch member spaced from said first latch member to provide multiple latching points for the double door arrangement to said door frame.

9. A latch and lock assembly according to claim 8, wherein the driver mechanism includes an elongated strip member with gear teeth set at appropriate locations along the elongated strip member to interact with corresponding gear teeth associated with the first latch member and each said additional latch member.

10. A latch and lock assembly according to claim 4, wherein a first latch member is provided, the latch member being mounted rotatably to interact with a latch strike plate fixed to or on said door frame to hold at least one of said first or said second doors in fixed relation to the door frame or to release one or both said first and said second doors from the door frame, the first latch member including first drive means engageable with second drive means on an elongated strip member to move said strip member in a longitudinal direction upon rotation of said first latch member towards a release position from said latch strike plate.

11. A latch and lock assembly according to claim 9, wherein a rotatable locking member is co-operable with said elongated strip member whereby in a first rotational position of said rotatable locking member said elongated strip member is prevented from movement in the longitudinal direction, and in a second rotational position of said rotatable locking member, said elongated strip member is capable of movement in said longitudinal direction.

12. A latch and lock assembly according to claim 11, wherein said electrical drive means drives a first gear member co-operable with gear formations on said rotatable locking member to selectably rotate said rotatable locking member.

13. A latch and lock assembly according to claim 12, wherein a lost motion mechanism is provided between said first gear member and said electrical drive means.

14. A latch and lock assembly according to claim 13, wherein said electric power source includes battery means carried in a housing compartment of the latch and lock assembly located on an inner side of said double door arrangement.

15. A latch and lock assembly according to claim 12, wherein the electrical drive means includes a controller arranged to place the electrical drive means in a standby configuration, said controller being activated by activation means located on an external side of the double door arrangement.

16. A latch and lock assembly according to claim 15, wherein the controller is located mounted in or to an external operative lever handle.
